(19) United States
(12) Patent Application Publication
(10) Pub. No.: US 2007/0027810 A1
(43) Pub. Date: Feb. 1, 2007

(54) Portfolio and resource tracking system

(75) Inventors: Julia K. Longnecker, Staunton, IL (US); Diane E. Walters, Rock Hill, MO (US); Steve C. Shaffer, Avon, IN (US)

Correspondence Address: BRINKS HOFER GILSON & LIONE, P.O. BOX 10395, CHICAGO, IL, 60610, US

(73) Assignee: SBC KNOWLEDGE VENTURES, L.P.

(21) Appl. No.: 11/298,174

(22) Filed: Dec. 8, 2005

Related U.S. Application Data
(60) Provisional application No. 60/704,282, filed on Aug. 1, 2005.

(51) Int. Cl. G06Q 99/00

(52) U.S. Cl. 705/51

(57) ABSTRACT

A portfolio and resource tracking system, including hardware and software, is presented that provides a single tool for tracking information related to software development. The system permits the technology and business aspects of a company to work closely with each other to better align the strategic objectives of the company. Snapshots of the information over the development cycle of the software may be taken with a desired granularity. Resources, both personnel and monetary, may be reallocated as a result and more accurate forecasting of operating expenses may occur. The system is in compliance standard processes.

### PRIORITY CLAIM

This application claims the benefit of priority under 35 USC §120 to U.S. provisional application 60/704,282, filed on Aug. 1, 2005, herein incorporated by reference in its entirety.

### TECHNICAL FIELD

This application relates to a system and method for tracking resources and a portfolio that is compliant with at least one standard model.

### BACKGROUND

Companies that produce a variety of internal and external software products typically have numerous new applications and revisions of existing applications in various stages. Multiple employees (who may include contractors as well as full or part time workers) are used on projects to produce requirements, design, code, and testing for a particular project for an application. Managers and employees are assigned different tasks dependent on his/her position. A number of managers at various levels oversee staff for this work. Furthermore, managers and employees are generally responsible for multiple projects on one or more applications. These managers must oversee the cost, schedule, status, and resources associated with multiple projects that make up a portfolio.

The information used to manage available personnel and track the cost, schedule, and status of various application projects can be enormous for large companies. This information includes aspects of development processes for application development projects, financial budgets established for the projects, and personnel information, for example. However, during the development process, resources that are initially estimated and allocated for the projects may need to be tracked, re-estimated, and/or redeployed. Technical issues during the development process, or new or altered business objectives or strategies may change the project, resulting in revised resource estimates and deployment. Also, due to the vast amount of information transmitted between the diverse managers, there may be a large and imperfect duplication in information regarding a project or project portfolio that is created and maintained. This makes it more difficult to maintain resource allocation, cost allocation, project/portfolio status, and the project/portfolio schedule. As a result, small differences between the information possessed by different managers may result in huge differences in cost, status, and schedule. Such disparity may cause the information to be viewed as suspect. This, in turn, may lead to a lack of trust between the business side of the company and the information technology (IT) side of the company, and a questioning of the business and/or IT strategy due to a misperception of the true cost of the strategy.

In addition, companies that develop software are increasingly turning to standard models like the Capability Maturity Model (CMM) or the Capability Maturity Model Integration (CMMi). CMM and CMMi were developed by the Software Engineering Institute (SEI) at Carnegie Mellon University and are formal, measurable, project management processes that lead toward a desired level of competency in software development that is recognized world-wide. These models provide five maturity levels (Initial, Repeatable, Defined, Managed, and Optimizing) for software development that must be in place to achieve those levels. Each maturity level indicates process capability and contains a number of processes directed at achieving goals and organized by common features, which address implementation and themselves contain practices that describe activities or infrastructure. The models enable the software development organization to consciously choose a certain target level of maturity, and to work towards that level.

Although progress has been made recently regarding the resource allocation and management, project scheduling, cost tracking, and status reporting, there is a need to combine many aspects of the IT side of a company to, among others, better track and manage all aspects of project work. This will enable close cooperation between the IT and business sides of the company while being in compliance with CMM and other standard processes.

### BRIEF DESCRIPTION OF THE DRAWINGS

FIG. 1 illustrates an embodiment of a portfolio and resource tracking system (PARTS).

FIG. 2 shows an embodiment of a screenshot of a Home homepage of an embodiment of PARTS.

FIG. 3 shows an embodiment of a screenshot of a Work Requests homepage of an embodiment of PARTS.

FIG. 4 shows an embodiment of a screenshot of a Work Request of an embodiment of PARTS.

FIG. 5 shows an embodiment of a screenshot of a Projects homepage of an embodiment of PARTS.

FIGS. 6A-6G show an embodiment of screenshots of project pages of an embodiment of PARTS.

FIGS. 7A-7C show an embodiment of screenshots of Applications pages of an embodiment of PARTS.

FIGS. 8A-8E show an embodiment of screenshots of Force Management pages of an embodiment of PARTS.

FIGS. 9A-9C show an embodiment of screenshots of Reporting pages of an embodiment of PARTS.

FIG. 10 illustrates an embodiment of a general computer system associated with PARTS.

FIG. 11 illustrates an example of granularity authorization.

### DETAILED DESCRIPTION

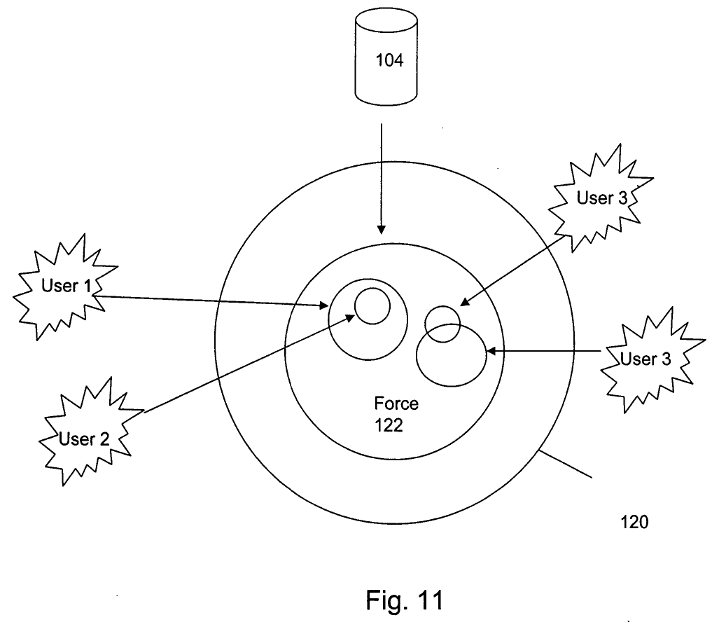

A method and system, as well as related hardware and software, are provided that permits tracking and management of software development projects at various levels of granularity and which are in compliance with CMM or other standard project management processes. Granularity may extend from an overview of the entire IT portfolio for a company to assignments, allocations, cost, schedule, and status of an individual software project. An example of granularity is shown in FIG. 11. FIG. 11 shows only the secured portion 120 of PARTS 100 and the Phone DB 104 and Force module 122 for clarity. As can be seen, four different users can access four different levels of granularity of the Force module 122. That is, user 1, user 2, user 3, and user 4 illustrate different individuals who can view and perhaps enter information for different subsets of all employees of the company.

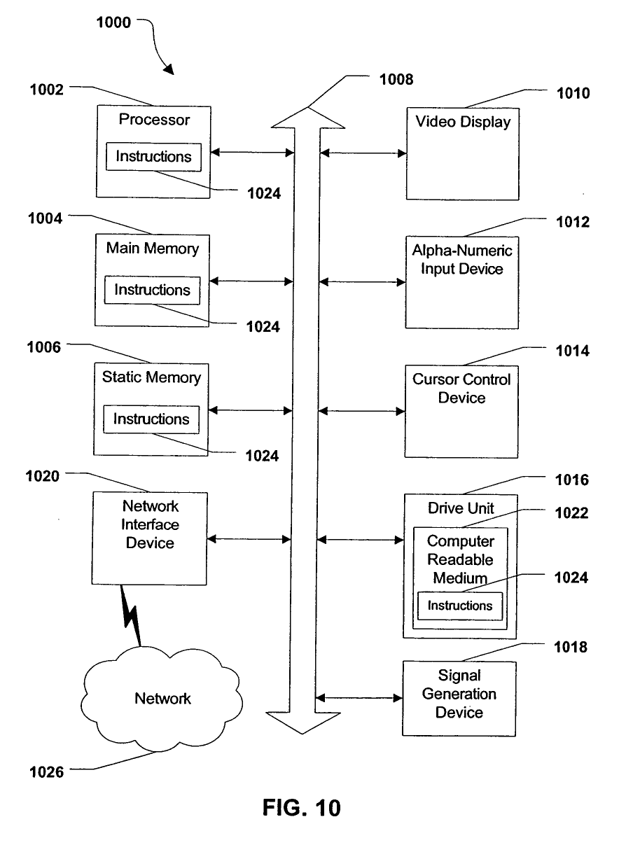

The embodiments may use a Graphical User Interface (GUI) through which data related to a project is entered and reported. The GUI may be viewed and/or information entered using any suitable electronic device, such as a computer. This is discussed in more detail below, with respect to FIG. 10. The data may be entered and are accessible over the internet or local connectivity systems.

Different software terms used below will first be described. A program is a term defined by an IT side or business unit of the company. A program contains one or more software application projects. Each program may have one or more managers (or technical directors) who are responsible for one or more projects. A project is a defined, scoped software development effort to produce a new application or make a change to an existing application, supervised by a project manager. An application is software that provides features and functionality to the business. The application will be developed or has been and is being used by the business. A client is a party who requests the functionality provided in an application through implementation of a project. The client may be internal or external to the company. Each application may have one or more projects associated with it and will have one or more project managers responsible for the project(s). Each project may have one or more associated work requests. Each work request may be, for example, a request to change features in an existing application or to produce a new application with particular features and functionality. The term company herein includes any business entity involved in software development, such as a corporation, a partnership, or a sole proprietorship.

The development cycle of software has multiple stages involving work requests, projects, programs, and applications. These stages may include: initiation of a work request for new software or modification of existing software, acceptance and funding, initiation of the software project, defining the requirements of the functionality, high level design of the software code, detailed design of the software code, writing of the software code, testing of the software code, signoff for the software code, documentation of the software code, implementation of the software, and production of the software for the use by the client.

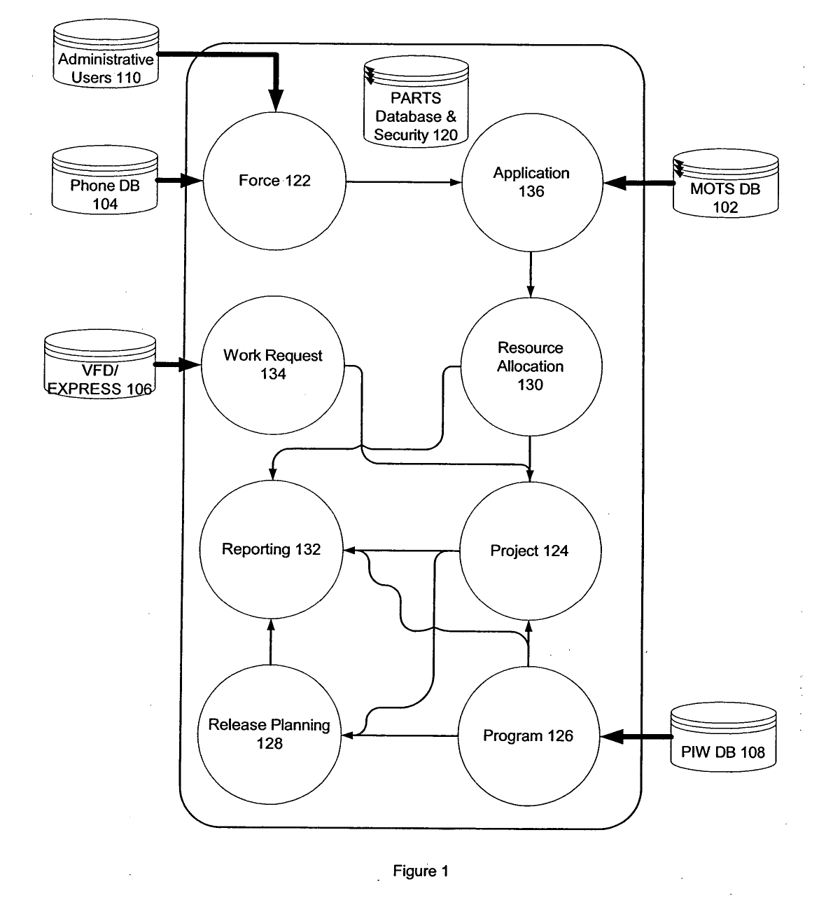

FIG. 1 illustrates an embodiment of a portfolio and resource tracking system (PARTS) 100. PARTS 100 has a large amount of functionality and contains different components, described below. As shown in the figure PARTS 100 may be a secure system which is accessible by predetermined users and draws information from individual databases (DB) updated by administrative users.

PARTS may be a single automated tool that permits multiple users to see, track, trend, manage, and understand the processes to get software development work accomplished for the company (or other organization). PARTS may have a GUI that is accessible at various levels of granularity based on the authorization of the user accessing PARTS. PARTS permits snapshots in time of the software development cycle from initiation of a work request, described below, to completion of a project and release of software to clients. Accordingly, in one non-exclusive example, PARTS permits simultaneous tracking and reporting of all existing software projects, business issues related to the software, and details regarding the personnel (e.g. coders, testers) involved in the project as well as the financial aspects, all of which while being in compliance with one or more standard models, such as CMM.

The databases that store the information for PARTS 100 can include a MOTS DB 102 (detailed application data), a PHONE DB 104 (detailed personnel data), a VFD/EXPRESS DB 106 (detailed work request data), PIW DB 108 (detailed program data). These databases may be maintained by a limited number of employees who are assigned to update and control the databases. Information from the databases may be updated on a regular basis, for example, weekly, by these employees. In contrast, especially with large companies, multiple databases of the same type may be maintained to a greater or lesser extent, and thus may have different information. The profusion of different employees having access to the same database may increase the number of errors in the database and may additionally cause a number of similar but different local databases to be generated. These local databases may then be mistaken by various employees as the original database, copied and disseminated.

To combat this, in the embodiment shown, information may be automatically transferred only from the databases 100, 102, 104, 106, 108 to the secured portion 120 of PARTS 100, which is accessible to users of the PARTS system. Information in this case does not pass from the secured portion 120 of the PARTS 100 back to the databases. Instead, only particular employees such as administrative users 110 are permitted to access and update information derived from the databases 100, 102, 104, 106, 108. By limiting the number of employees involved in updating the databases 100, 102, 104, 106, 108 as well as the direction of information flow, the chance of errors in the databases 100, 102, 104, 106, 108 may be decreased. In other embodiments, however, information can flow in the opposite direction, through well defined security. The databases 100, 102, 104, 106, 108 thus house core data from a particular field, thus reducing replication of information across multiple databases.

This is not to say that information in the secured portion 120 is only available through the databases 100, 102, 104, 106, 108. Information entered into the secured portion 120 by administrative users may be immediately accessible to other employees who have access to the information being entered.

In the embodiment shown, the information from the databases may flow into the secured portion 120 or PARTS 100. The various modules in the secured portion 120 or PARTS 100 can be implemented through the PARTS database that stores the information derived from the other databases further defined below. Examples of this information stored in the PARTS database include: personnel data, application data, work request data, and program data.

Turning to the specific databases, the MOTS DB 102 may contain the information of all the software applications developed or purchased and in production or in development by the company. For example, the MOTS DB 102 may contain full descriptions of the applications, application acronyms, the language the application is written in, how the application is maintained, the managerial hierarchy responsible for the application, as well as backup and disaster recovery information.

The Phone DB 104 may contain the information regarding the work force of the company, the personal information of the employees used by human resources.

VFD/EXPRESS DB 106 is the Virtual Front Door/EXPRESS database. It may contain the information for entry of all work requests and is the entry tool for work submitted to the IT organization.

PIW DB 108 is the Program Initiation Worksheet database. The PIW DB 108 may contain the information regarding programs, including the financial information about the program.

The modules within PARTS 100 may include Force 122, Project 124, Program 126, Release Planning 128, Resource Allocation 130, Reporting 132, Work Request 134, and Application 136. The modules may be portions of software or memory in which software is stored. The administrative users may have the ability to change data within the various components of the modules within the secured portion 120. For example, they may have the ability to add, delete, or change personal information about an employee, the authorization for access within PARTS, or the software that the employee is involved in and their corresponding role within the software or within the company.

Force module 122 may contain information about the work force of the company. Project module 124 and Program module 126 may contain information about the company projects and programs, respectively. The Resource Allocation module 130 may involve the planning of company resources, e.g. personnel, financial, and computer-related resources. Release Planning module 128 may involve planning of release of the software. Reporting module 132 may provide reporting of various aspects of the software development to the PARTS user. Work Request module 136 may contain information about the work requests that have been entered into the system. Application module 136 may contain information about applications that have been developed or are under development.

Phone database 104 as well as the administrative uses 110 may supply data to the Force module 122. MOTS database 102 may supply data to Application module 136. VFD/Express database 106 and PIW database 108 may supply data to Work Request module 134 and Program module 126, respectively. Data in Force module 122 may be supplied to Application module 136. Data in Application module 136 may be supplied to Resource Allocation module 130. Data in Resource Allocation module 130 may be supplied to Project module 124 as well as Reporting module 132. Project module 124 may also supply data to Reporting module 132 as well as Release Planning module 128. Program module 126 may also supply data to Reporting module 132 as well as Release Planning module 128 and Project module 124. Data in Work request module may be supplied to Project module 124. The modules shown in FIG. 1 may be implemented as described below.

The various databases 100, 102, 104, 106, 108 and modules 122, 124, 126, 128, 130, 132, 134, 136 within the secured portion 120 of PARTS 100 can be stored in and/or available on any number of electronic components, which are networked together. For example, the databases can be stored in the same electronic storage system (e.g. server) or individual storage systems.

As above, PARTS supports the standard model throughout the various modules contained within the overall system. First, a standard model such as CMM requires the ability to communicate project status to levels of management throughout the software development life cycle. The Reporting module 132 provides the capability to structure status reports on all facets of a project based on the audience and request at anytime during the software development life cycle. In addition, any manager can access PARTS at any time to see the current status of the project. Second, PARTS enables the tracking and communication of project team members, jeopardizes, risks, dependencies, issues, estimates, deliverables, milestone completions, and releases for all projects. All of these are required to be CMM compliant. Third, PARTS enables analysis and metrics collection for projects through the Reporting module 132, another requirement of CMM. In total, CMM contains many pages of documentation and specifications to be in compliance with CMM. While a copy of the basic platform/framework of CMM may be found in “The Capability Maturity Model”, published by the Carnegie Mellon University Software Engineering Institute, ISBN 0201546647, herein incorporated by reference, additional components may be added as desired.

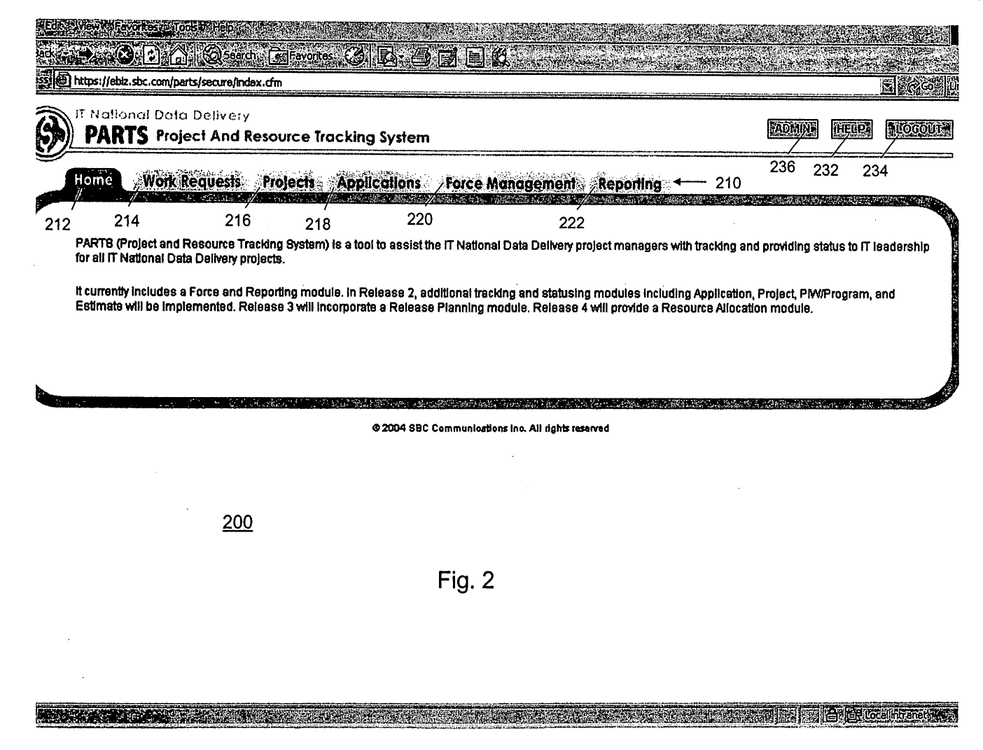

FIGS. 2-9 illustrate examples of PARTS displayed as various pages (illustrated as one or more screenshots). The details provided are to be taken as exemplary only; other information may be available as desired dependent on the particular implementation of PARTS. Similarly, the physical layout of the links on each page as well as the links may be altered as desired. As shown in these figures, for example in FIG. 2, the GUI 200 for PARTS can be implemented using any suitable software, such as a commercially available world wide web (www) browser. A number of hyperlinks (links) corresponding to access to different information are available, as shown by folders 210 in the page. The folders in the embodiment shown include: Home 212, Work Requests 214, Projects 216, Applications 218, Force Management 220, and Reporting 222. The folders or labels on the folders are examples of links which are graphics or text string that, when clicked, open a new web page.

Each folder is linked to a web page associated with that folder. When activating the link, the web page selected may be loaded into a computer associated with the display and then displayed. The computer may be local, e.g. a personal computer, or remote from the viewer. The viewer may be transported to the desired page, either directly or through one or more other pages, such as a security page. In one embodiment, a user accessing PARTS is prompted to login using a username and password. This can either be through a secondary, pop-up window or through an intermediate page. Once logged in, on each of the pages linked to the folders, other links permit the view to access help 232 for PARTS, logout 234 from PARTS, or access administrative functions 236.

Selection of a link may be accomplished by any selection mechanism known in the art. The selection mechanism may include a touchpad, mouse, joystick, or voice activation, for example.

The Home folder 212 as shown in FIG. 2 contains an introduction to PARTS for the first time user. As shown, this introduction may be merely a sentence or two or may be extended to provide a longer introduction to PARTS. Additional information may be included, such as updates to PARTS, system notices, or other information that an administrator/manager believes should be displayed for PARTS users.

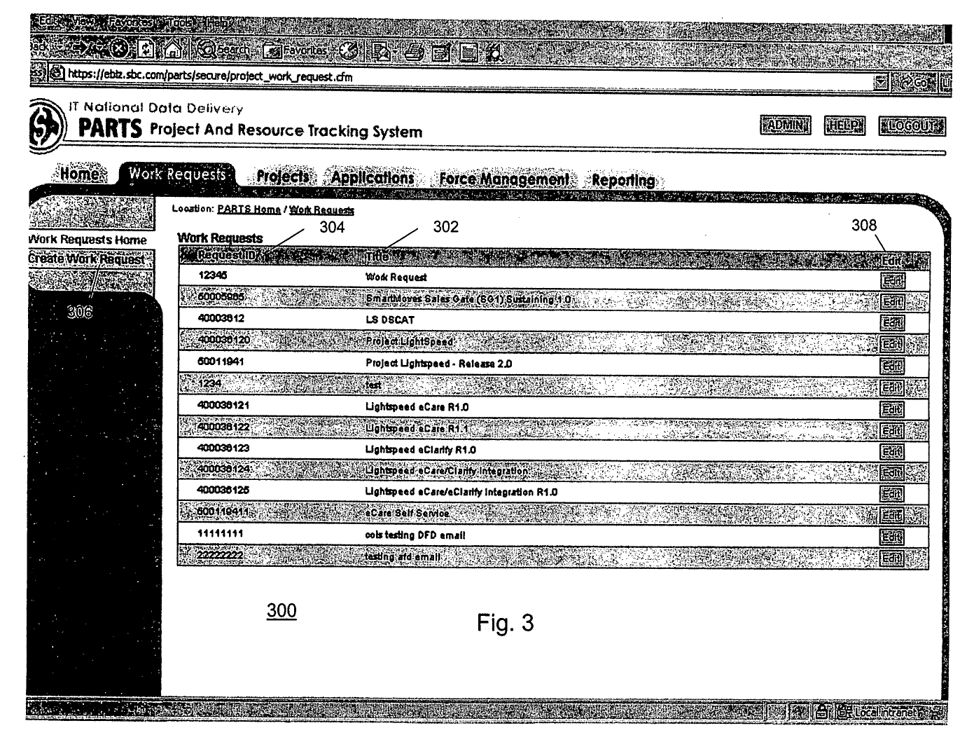

The Work Requests home page 300, shown in FIG. 3 shows the title 302 of a set number of work requests and associated ID numbers 304. As mentioned above, a work request is a request for performing a task related to software development that is submitted by a client. Such a task may include modification of existing software or creation of new software. As companies generally have multiple units or organizations, each of which is tasked to perform a different assignment, the client may be internal to the company. In this case, the client can be an individual or business unit (or other group) of the company. A work request may be created by one or more individuals entering the desired information in the Work Requests pages of the GUI and, when the appropriate information is completed, saving the information to be accessible to other users. The saved information may be updated and changed by users able to access the information. In a similar manner, all data entered in all pages may be entered, saved, and updated/changed. In addition, some of the data fields in the various pages may be eliminated or data fields may be added. Thus, the descriptions below may be modified as desired.

The work requests are provided in any desired order on the web page. For example, they can be grouped overall chronologically (e.g. when entered or when needed to be started or completed), alphabetically, or per importance level, or grouped per application or project in the same manner. The home page 300 of the Work Requests tab 214 has a link 306 that permits creation of new work requests and a link 308 that permits editing of any of the displayed work requests.

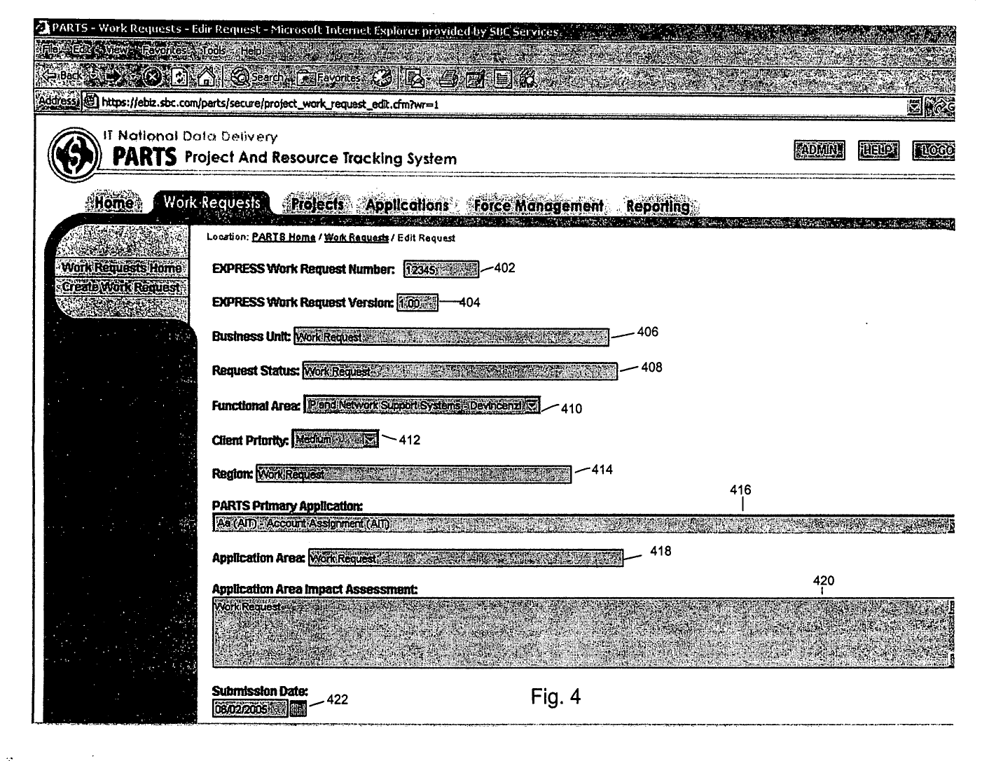

Selecting the link 308 that permits editing of one of the displayed work requests loads data from the computer storing the work request data and displays the data. The data includes multiple data fields that may be manipulated by the user. One embodiment of the information displayed is shown in FIG. 4. The data fields may include: the work request ID number 402, the version of the work request 404, the business unit 406, the request status 408, the functional area 410, the client priority 412, the region 414, the primary application 416, the area of the application 418, an assessment of the impact on the application 420, and the submission date 422.

The work request ID number data field 402 contains the ID number used to identify the work request in FIG. 3. This ID number is unique to the work request throughout all of the pages of PARTS. The version of the work request data field 404 identifies the number of times the work request 404 has been modified. The business unit data field 406 indicates the business unit from which the work request will draw funding.

The request status data field 408 indicates the status of the work request. For example, the request status data field 408 indicates whether the work request has been considered yet; whether the manager(s) have reviewed the work request, the work request has been granted, and/or an initial estimate has been made.

The functional area data field 410 indicates the general area to which the work request applies and perhaps the manager for that area. In the example illustrated, the functional area is internet protocol (IP) support and network support systems.

The client priority data field 412 indicates the priority assigned by the client. Multiple priorities exist, for example, low, medium, or high. The client priority aids in determining where the work request should be placed in the queue for allocating resources.

The region data field 414 is used to determine the region to which the work request is assigned. The primary application data field 416 indicates which existing application, if any, within the business unit and region the work request is to be allotted. The application area data field 418 indicates the area of the application to which the work request is assigned.

The application area impact assessment data field 420 is used to assess the impact of the work request on the application. Unlike the other data fields in FIG. 3, which may be selected from pull-down menus, the entry in the application area impact assessment data field 420 is in paragraph form to better permit the employee requesting the work request to explain the impact of the work request on the affected application and better allow the manager(s) or board assessing the work order to determine the effects on the application.

The submission date data field 422 indicates the date of submission of the instant version of the work request. The use of all of these data fields allows the work request database to be in compliance with CMM and individual work requests to be better assessed for desirability within the strategy of the business unit and/or company.

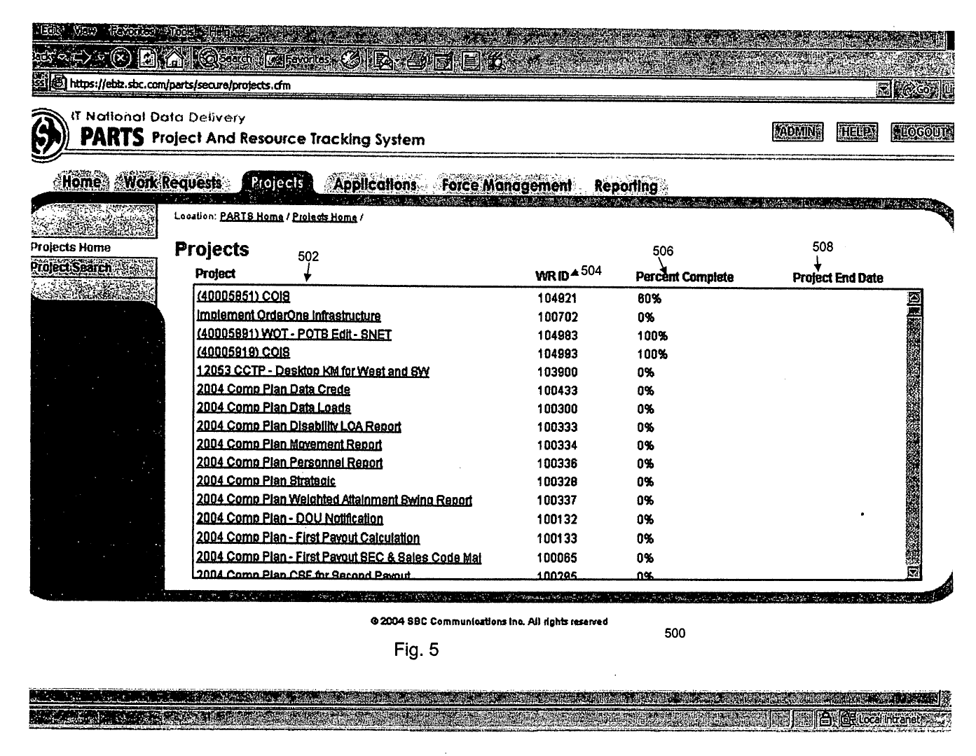

Turning to FIG. 5, which illustrates an example of the Projects homepage 500, this page provides a list of projects 502 whose characteristics are accessible by selecting the desired project. In addition, a work request (WR) ID number 504 identifying the project is listed, as are the percentage completed of the project 506 and the projected and/or actual end date of the project 508. The Projects homepage 500 also has a link that permits searching for a particular project by name or ID number.

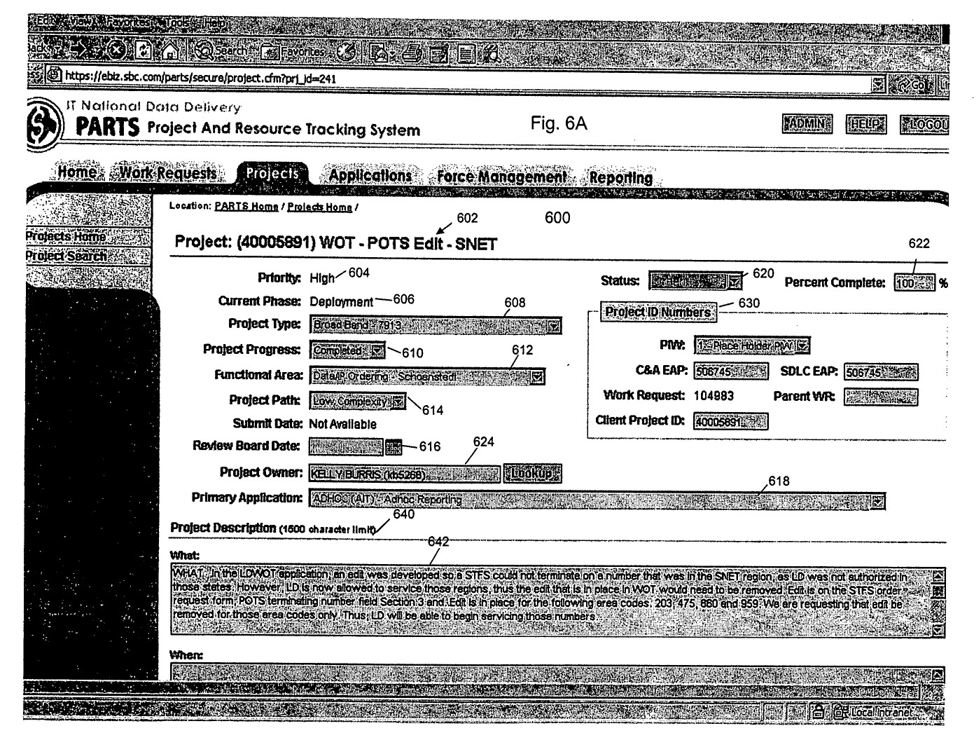

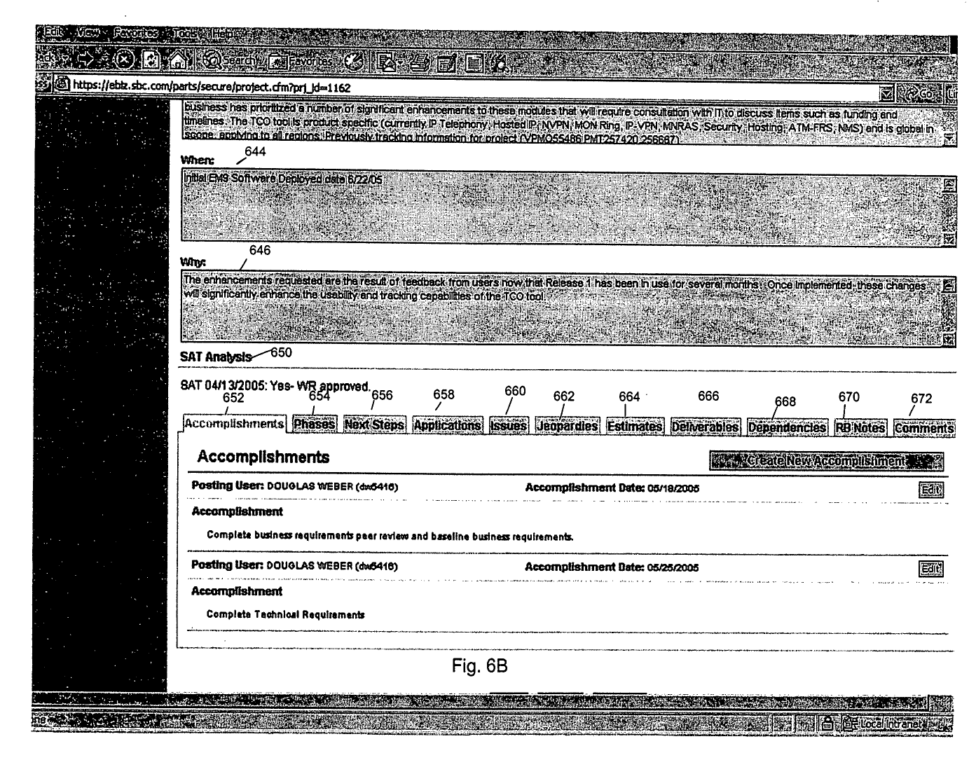

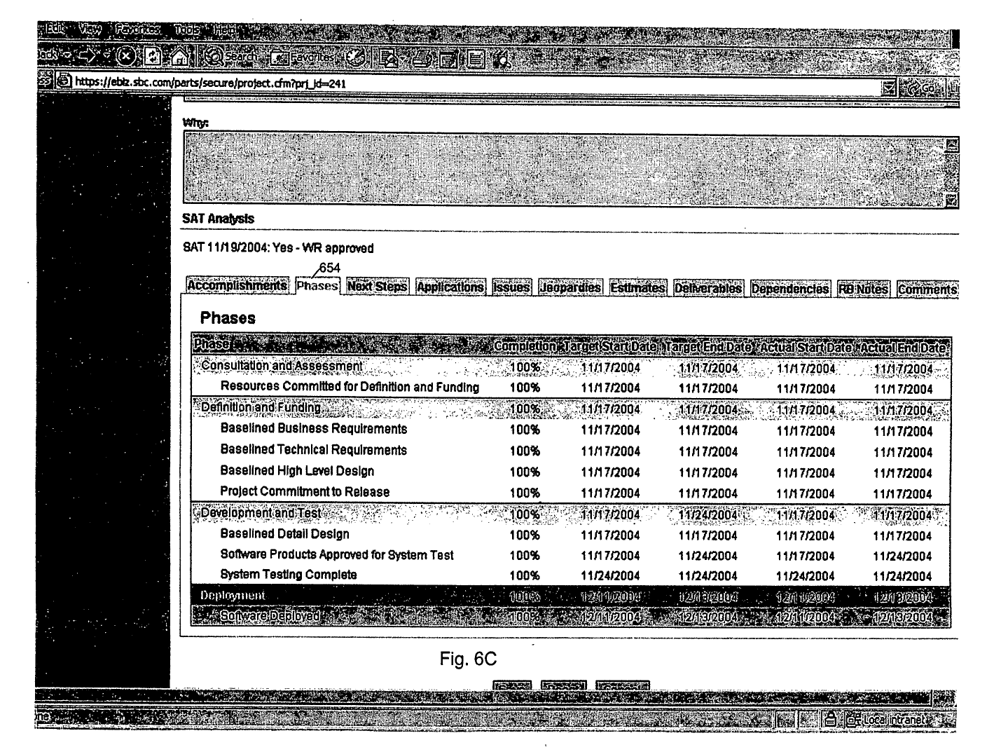

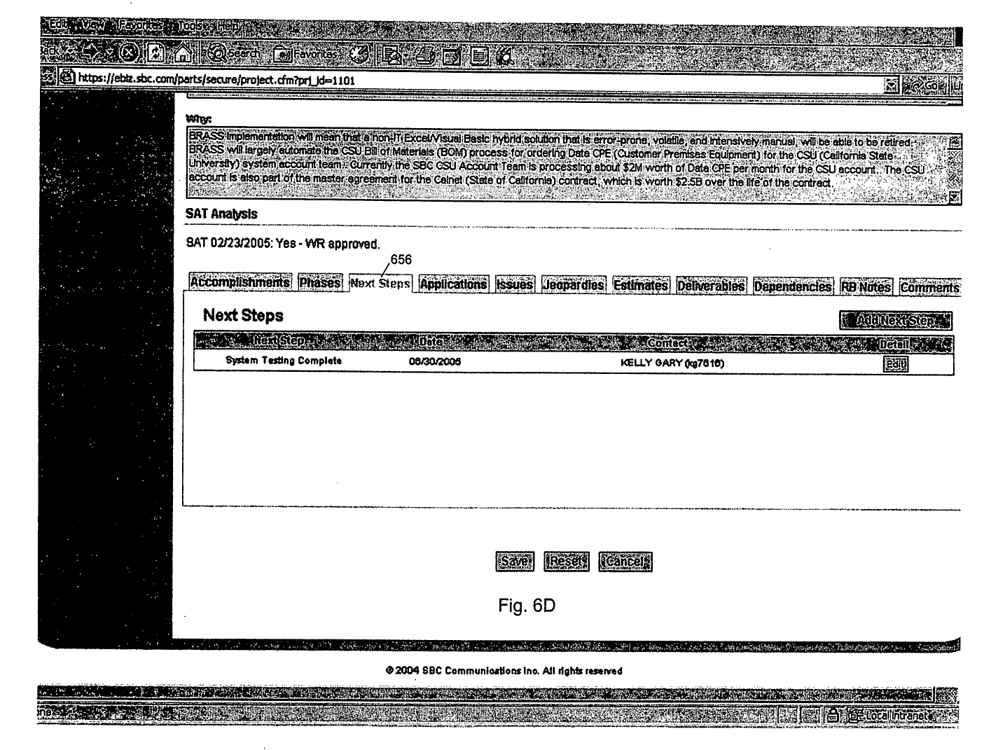

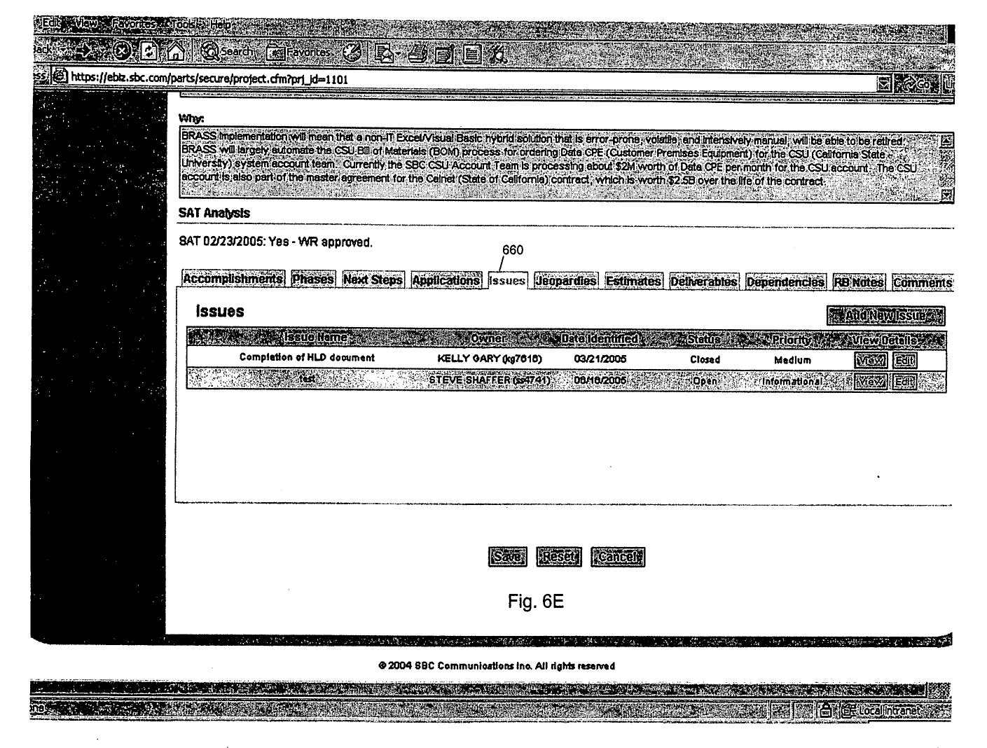

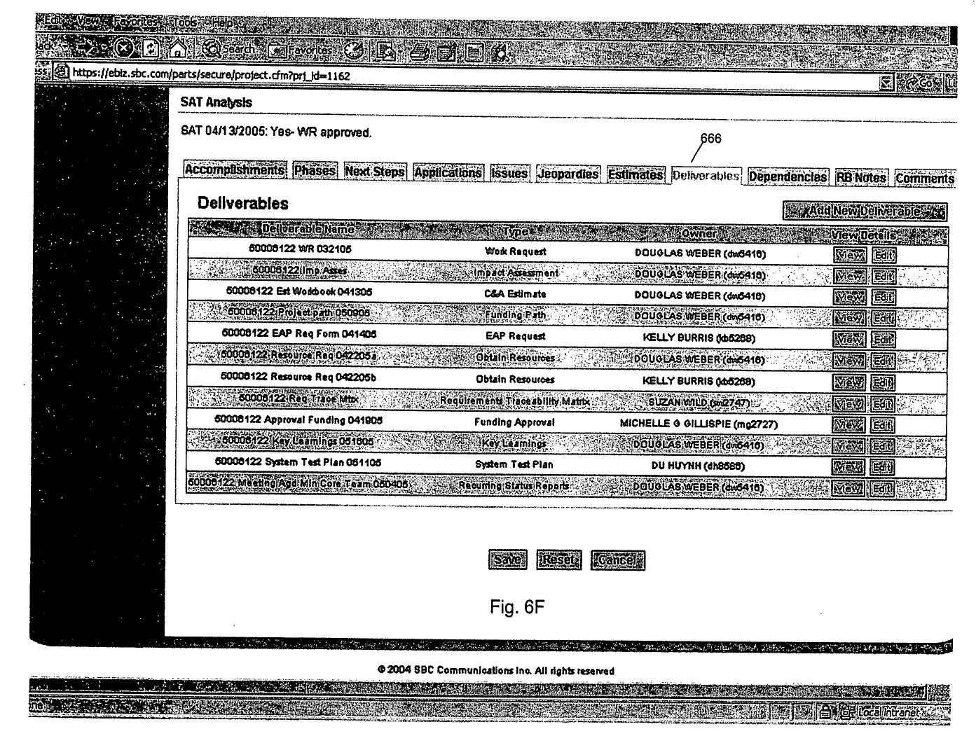

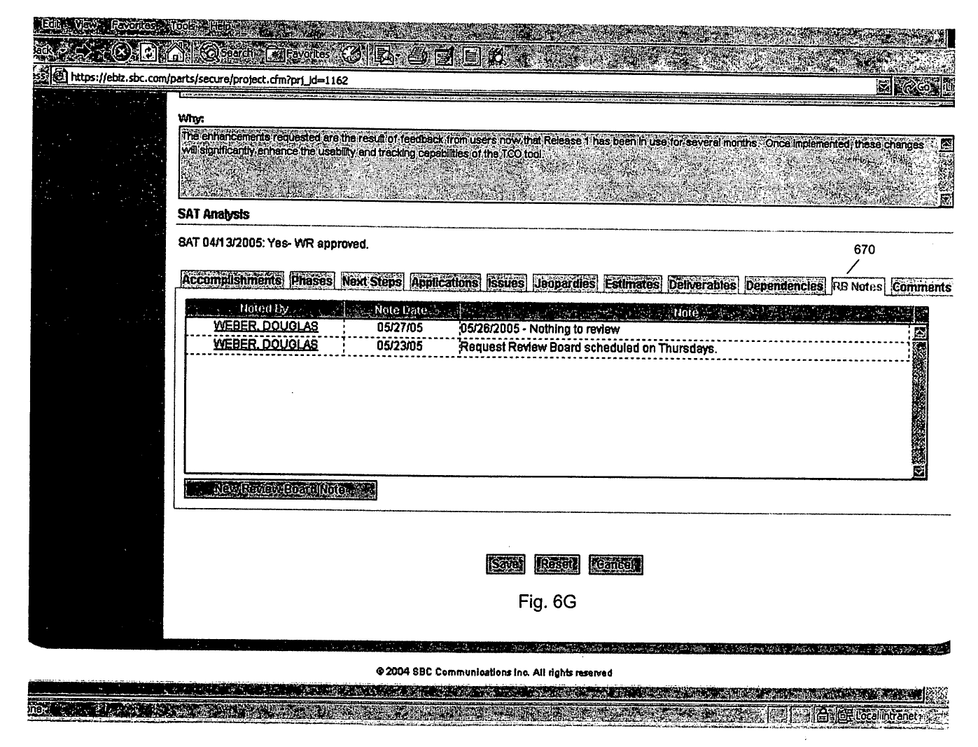

Selecting a particular project on the Projects homepage 500 brings up a display such as that shown in FIG. 6A. Multiple data fields are shown, some of which are unchangeable and some that are alterable, e.g. pull-down windows with set selections for data to input or data boxes in which the user can enter text. The project summary 600 shown in FIG. 6A includes the selected project name and ID 602 displayed at the top of the page and various data fields associated with the project. All of the numbers associated with the project are grouped in a separate project ID section 630. These numbers include the work request number of the project, various numbers used in accounting, the parent work request number (if multiple versions of the work requests exist), and the client ID number.

As shown in FIG. 6A, the priority data field 604, which indicates the priority of the project, and the phase data field 606, which indicates the phase of the project, is unable to be altered by employees other than an administrator or project manager. The phase of the project indicates, for example, whether or not the project has been reviewed, accepted or deployed.

Similarly, data fields that are pull-down windows in the embodiment shown in FIG. 6A include the project type data field 608, the project progress data field 610, the functional area data field 612, the project path data field 614, the primary application data field 618, and the project status data field 620. The project type data field 608 designates the category of the project in terms of the various types of projects, which are coded with ID numbers, while the functional area data field 612 designates the overall area type to which the project belongs as well as the manager overseeing that area. The project progress data field 610 indicates whether the project has been started, is in progress, or has been completed. The project path data field 614 indicates the estimated complexity of the project. The primary application data field 618 indicates the application for which the project has been approved and in which the project will be instituted. The project status data field 620 indicates whether the project has been approved to proceed (green) or whether the project is on a temporary delay/has been terminated (red).

Data fields in which numbers can be entered include the review board date data field 616, which has a pop-up calendar that indicates when the review board met or is next scheduled to meet to review aspects of the project. In addition, the percentage completion data field 622 permits the manager to update the amount of the project estimated to be completed at the time of entry. This percentage may include both creation and debugging of the code. The project manager is also listed in a project owner data field 624, and a separate selectable element permits the viewer to look up information about the project manager.

Further, extended data fields in which a substantial amount of text can be entered are disposed in a project description section 640, which is shown in FIGS. 6A to 6B. The project description section 640 has three different entry portions: What 642, When 644 and Why 646. In the What data field 642, the client enters a description of what the project is attempting to do. In FIG. 6B, the When data field 644 permits the client to enter the timeline of the project such as when the project is to be started and completed. The Why data field 646 is the location in which the client enters the particular problem to be solved and how the project came about.

The page also contains an analysis of the project in a project analysis section 650, as shown in FIGS. 6B to 6G. Individual aspects of the analysis, which are arranged as file folder tabs, are able to be selected. The aspects include: accomplishments 652, phases 654, next steps 656, applications 658, issues 660, jeopardies 662, estimates 664, deliverables 666, dependencies 668, notes of the review board 670, and other comments 672. The various aspects may be edited in a number of different ways. The applications 658, jeopardies 662, estimates 664, and dependencies 668 pages are not illustrated for brevity. The applications 658 page details all of the applications to which the project can be applied and the effects thereof. The jeopardies 662 page provides a history of all of the problems and setbacks for the project. The estimates 664 page provides a detailed history of the estimated and actual costs, and when the finances for the project were secured and disbursed.

The history of the accomplishments 652, shown in FIG. 6B, is listed in chronological order. New accomplishments may be created or existing accomplishments edited. As multiple users may be able to enter data, the history indicates the name and email address of the particular user who entered the accomplishment, the date of the accomplishment, and what the accomplishment is.

The project phases 654 document the history of the various software milestone and business aspects of the project. One such page is shown in FIG. 6C. The information displayed includes the percentage completion, and the target and actual start and end dates for each milestone/aspect. As shown, these phases include the initial assessment of the project and when resources were committed to the project, determination of the business and technical requirements, completion of the high level design for the code and release date, implementation of the detailed code design and approval and testing of the code, and deployment of the software to the client.

The next steps 656 page, shown in FIG. 6D, illustrates the next step that the project is to undergo. The name of step is listed, as is the date by which the next step is to be completed. The contact information (e.g. name and email address) of the individual handling the next step is also listed. Each of these fields, as the majority of the other fields discussed herein, are able to be edited.

The issues 660 page, shown in FIG. 6F, permits the user to view various issues that have arisen during development of the software. The issue name is shown, as is the individual who identified the issue, the date the issue was entered into the record, the status of the issue (i.e. whether it is still ongoing or whether it has been resolved), and the priority of the issue to the software. The different issues can be viewed in detail and edited. New issues can also be added for management or team members to view.

The deliverables 666 page is illustrated in FIG. 6G. As shown, this page provides details of the internal and external deliverables, i.e. the tangible outcomes produced by the project. The name and ID code of the deliverable is listed, along with the type of the deliverable and the information of the individual responsible for obtaining the deliverable.

A history of the review board notes is displayed on the RB Notes page 670. In the example illustrated in FIG. 6G, each note is displayed, as is the date the note was entered, and the individual who entered the note.

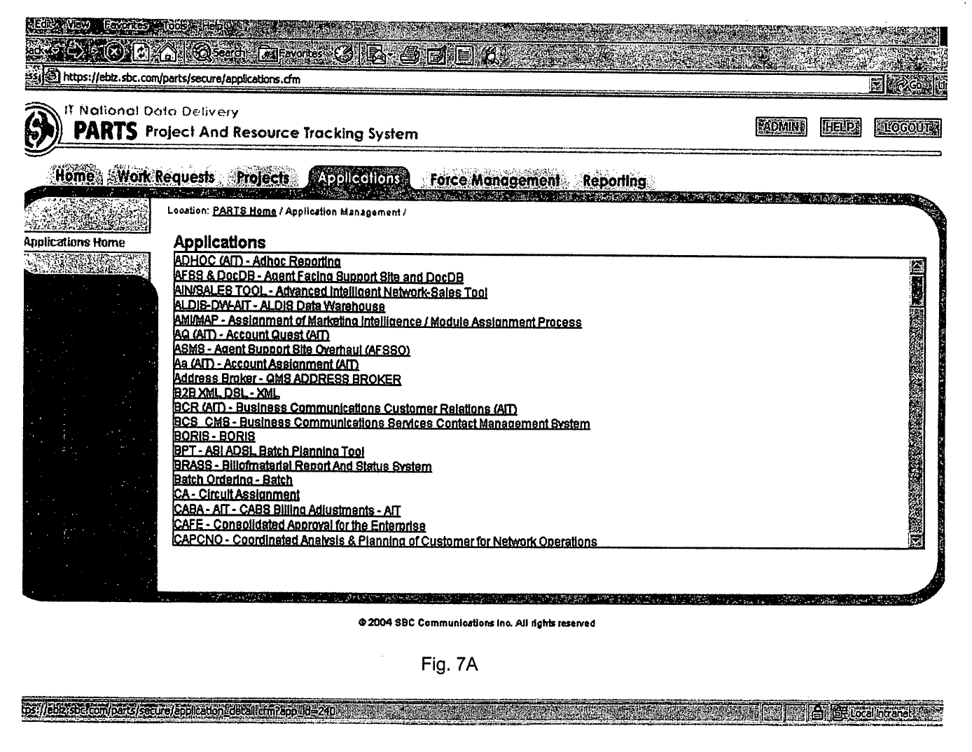

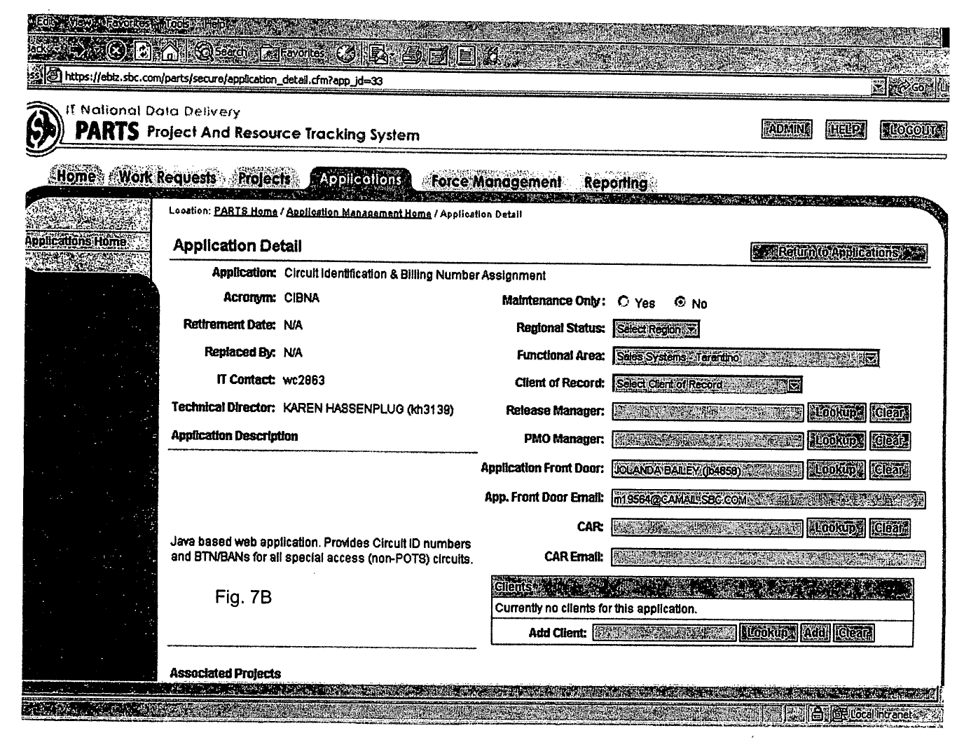

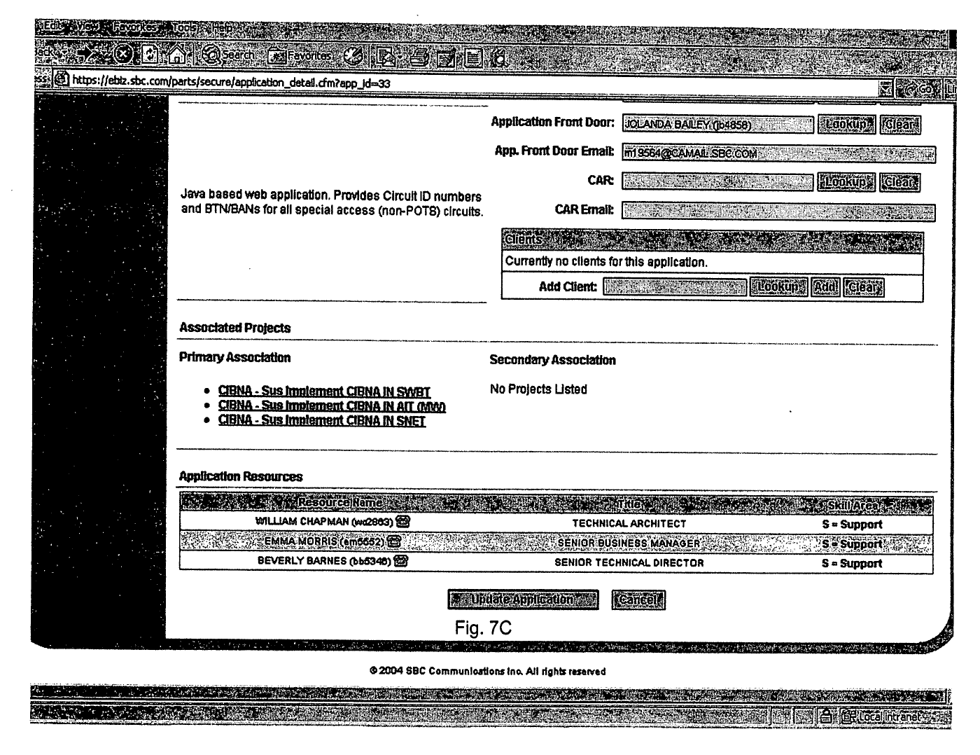

The Applications folder 218, shown in FIGS. 7A-7C contains details about all of the application that exist. The applications can be completed, currently in progress, not yet started, or abandoned, for example. As shown in FIG. 7A, the applications may be listed in alphabetical order or may be listed using chronology, status, amount of resources allocated, manager, or any other desired feature.

Selecting one of the applications listed in FIG. 7A brings the user to the screen illustrated in FIGS. 7B and 7C. Details of the selected application have been previously entered and are displayed. These details include the full name of the application as well as its acronym and description of the application. The date the application was retired, that is, no longer desirable from the business or technological side of the company, is shown. At this date, the allocation of resources is terminated. The Replaced By data field displays other software if the application has been replaced by a newer version or different software package. In addition, contact for the technology manager contact and technical director are displayed.

Other data fields are able to be changed by the user include whether or not the application is for maintenance, and pull-down windows indicating the region of the company that is responsible for the application, the functional area of the application, and the client for which the application is being prepared. Text inputs permit editing of the managers for the application (as well as the ability to lookup information for the managers), the contact individual and contact information, and CAR and contact information. If one or more clients exist for the application or the client base needs to be changed, a separate input data field is present for the addition, removal, or contact information for the client.

Other projects that are associated with the selected application are accessible by links. These projects may be associated either by a primary association or secondary association. Further, the resource individuals, titles, skills, and contact information are listed for quick access by the viewer. If it is desired to make changes to the application, the changes can be reviewed and entered or cancelled by separate selector buttons displayed on the screen.

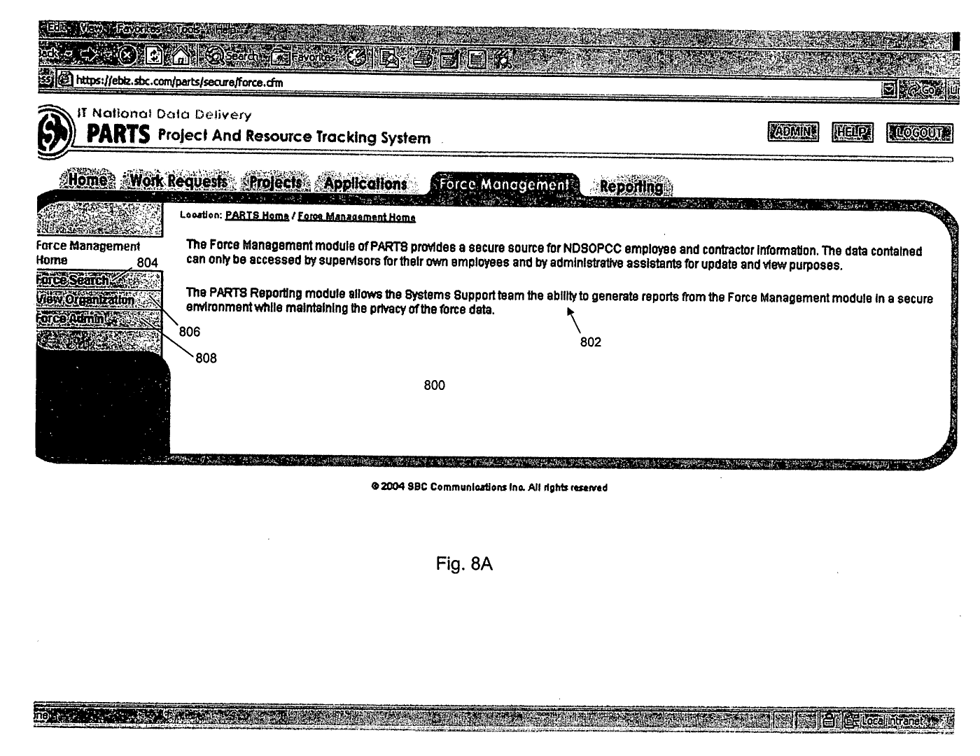

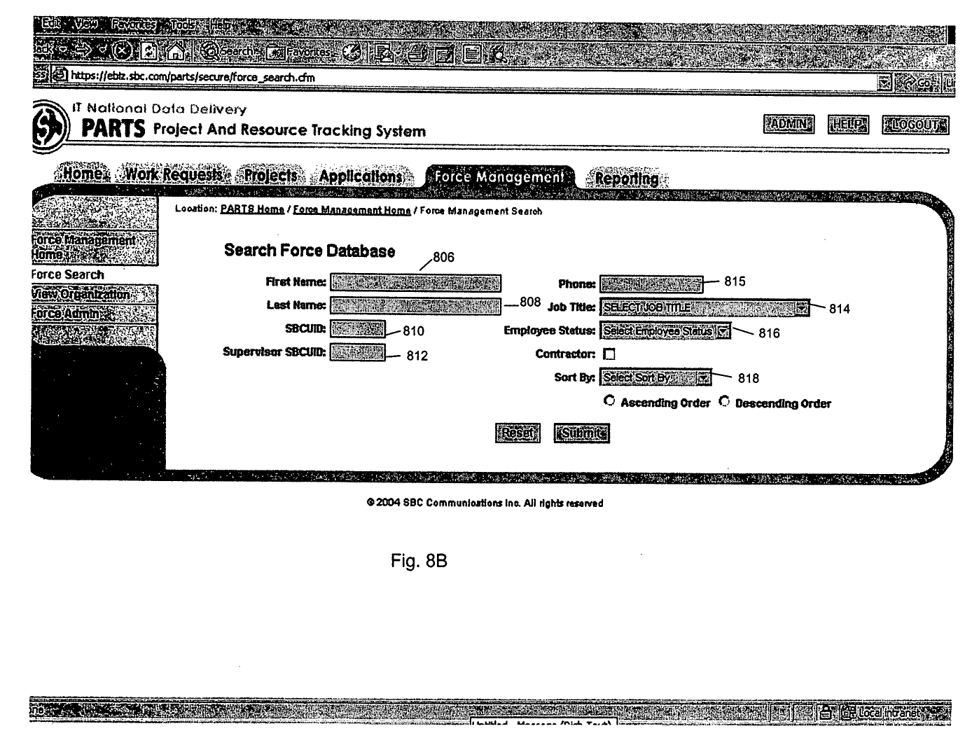

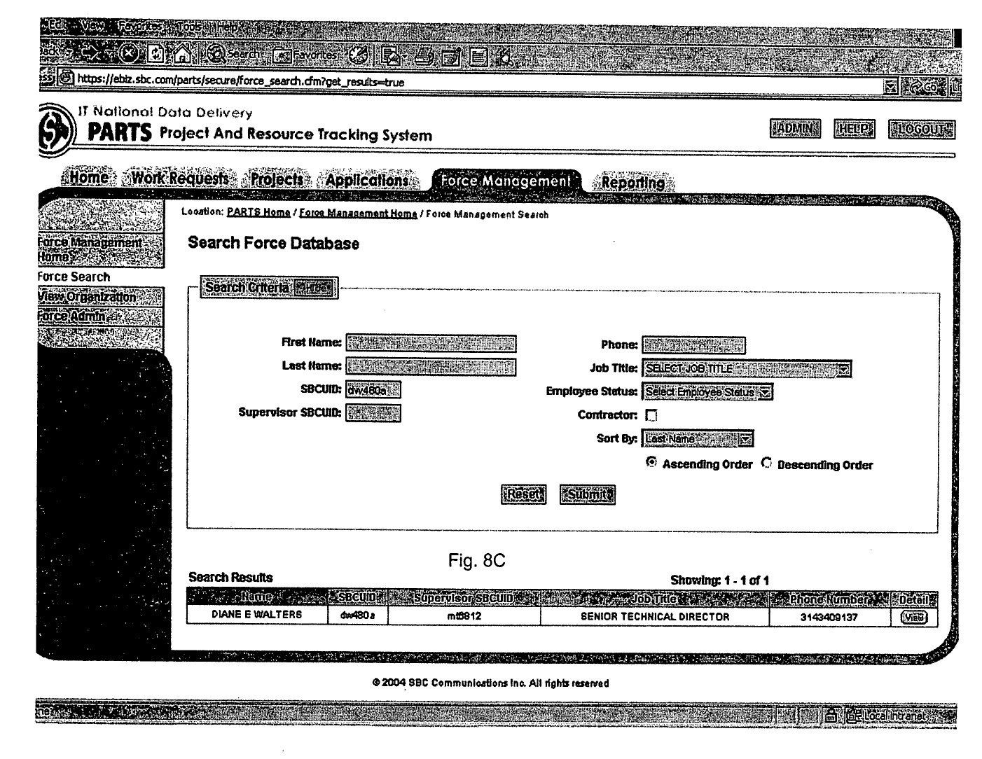

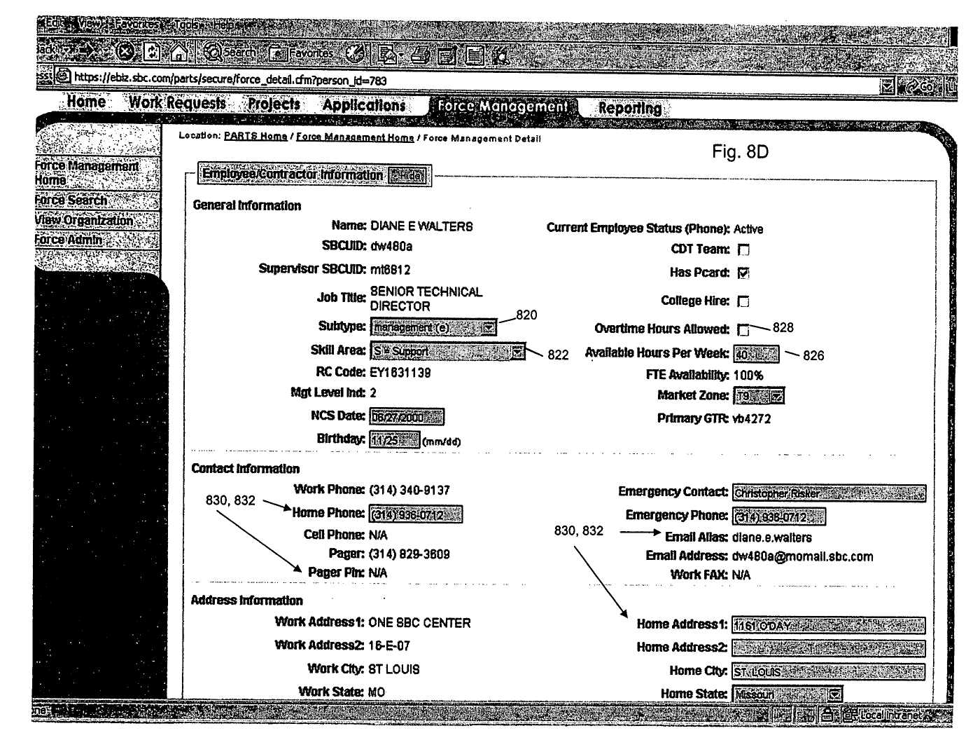

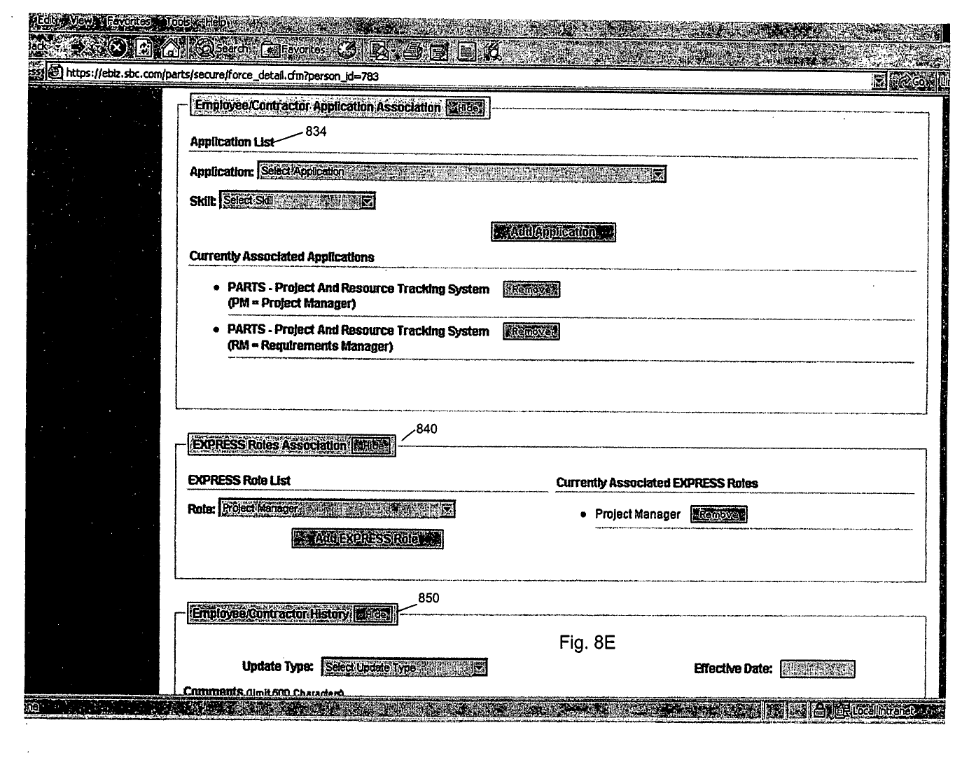

FIGS. 8A-8E are screenshots of the Force Management folder 220 of FIG. 2. The homepage 800 of the Force Management folder 220 shown in FIG. 8A provides introductory remarks and notes for the viewer 802. Links are provided for searching the labor force 804, viewing various organizations within the company 806, and administration of the labor force 808. Reporting of the labor force allows determination of the availability of personnel for a particular application/project, the amount of time the personnel are spending on the particular application/project, the overall roles and job titles of the personnel and their roles on the particular application/project. This, for example, permits a manager to quickly see who is available, who is overscheduled, and perhaps reassign work, if necessary, for the particular application/project.

After selecting the searching the labor force link 804, the screen of FIG. 8B is displayed. Searches can be performed to pull up employees by entering a first name 806, last name 808, employee ID (SBCUID) 810, or phone number 815. A group of employees can be found by entering the ID of the Supervisor (SBCUID) 812 who oversees the group or by selecting a job title 814 or employee status 816 from a set supplied in a pull-down window. Whether the employee is a full or part time employee, a current, retired, or previous employee, or a contractor, for example, can be selected. In addition, further modality is provided by permitting the viewer to select the mechanism by which the group of employees returned by the search is sorted 818. For example, the group can be sorted by name or ID number and in ascending or descending order.

Once the information is entered, a search of the information in PARTS is performed using information provided from the Phone DB 104. As shown in FIG. 8C, the search returns a number of useful fields for the employee(s) including: name, ID number, Supervisor ID, job title, and phone number. In addition, further detailed information is available for a particular employee returned by the search, as shown in FIG. 8D. Besides the information shown in FIG. 8C, information such as the subtype 820 of the job and skill area 822 associated with the selected employee is adjustable via pull-down window. The number of hours per week that the employee is permitted to work (e.g. full time=40 hours, part time<40 hours) 826 is able to be adjusted as is an indication of whether overtime 828 is permitted to be entered for the employee is also provided. Personal information such as work and home contact and address information 830 and 832 are also displayed to the viewer.

The selected employee may be associated with a number of different applications in various relationships. For example, for a first application, the employee may be one type of manager and thus be responsible for a certain set of duties, while for a second application, the employee may be another type of manager and thus be responsible for a different set of duties. This information may be viewed using a pull-down menu and added or removed in the Application List section 834 of the Force Management folder 220 for the particular employee selected. Similarly, the role of the selected employee in implementing the standard model used, such as EXPRESS, may be viewed and revised in the Roles section 840 of the Force Management folder 220. Additionally, the history of the employee is shown in the Employee History section 850.

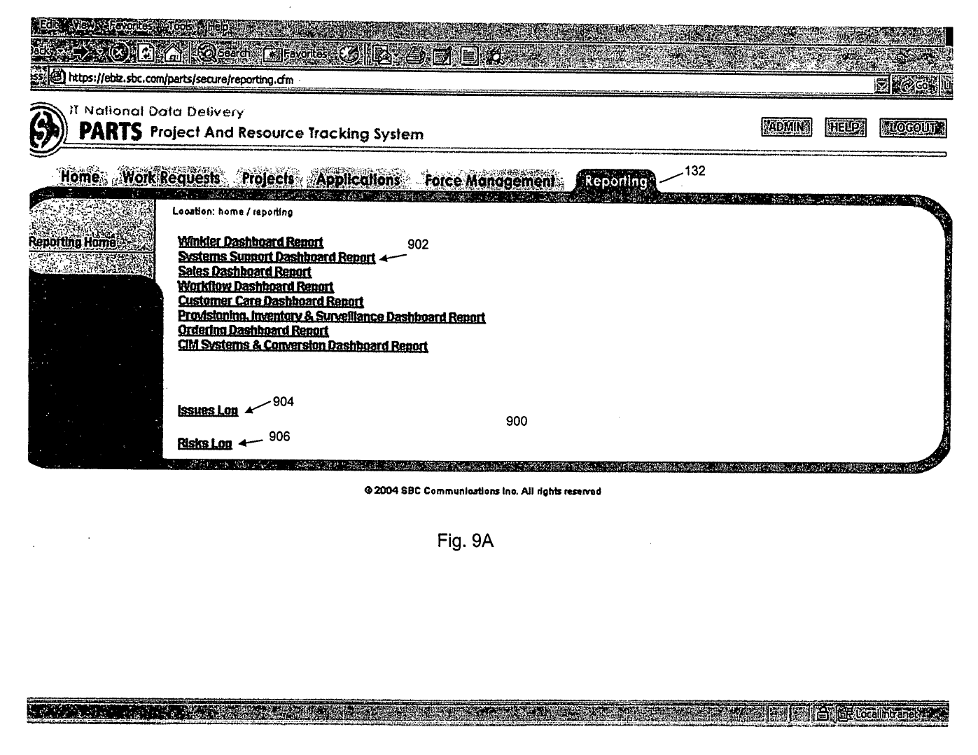

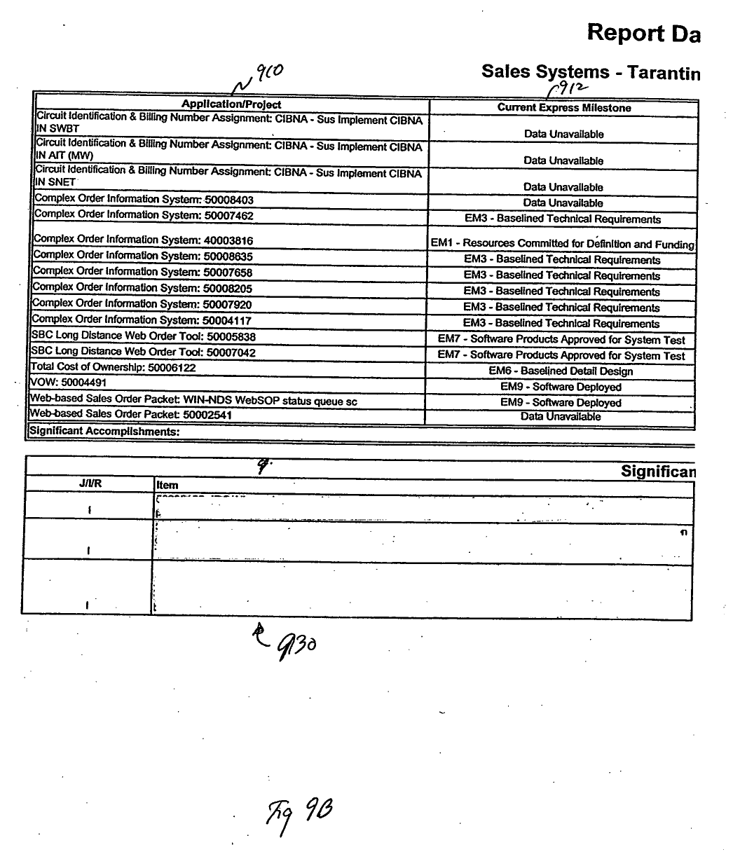

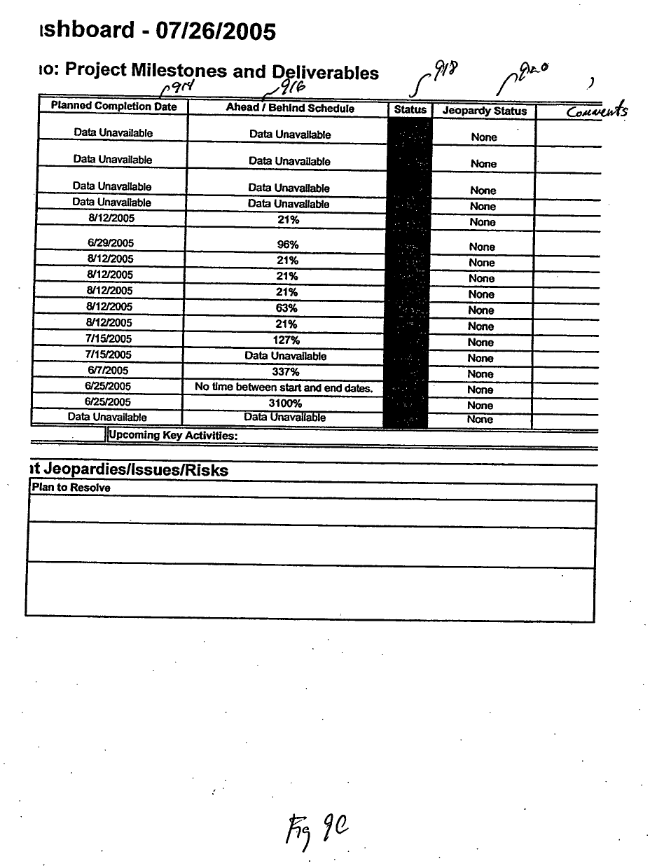

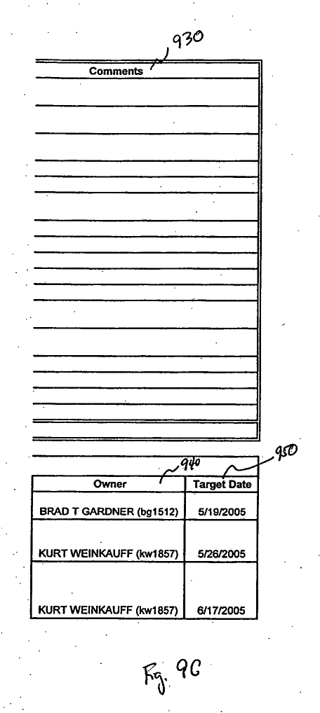

Referring to FIG. 9, the Reporting folder 132 has a Reporting homepage 900, shown in FIG. 9A, that provides links to the full report on particular programs 902, as well as links to chronological listings of all issues 904 and risks 906 for each piece of software in development or being modified in the programs.

Activating one of the links brings up a page or spreadsheet for all of the applications and projects associated with a particular program, as shown in FIGS. 9B and 9C. The spreadsheet is a summary that includes the application/project name 910, the milestone currently being worked toward 912, the estimated completion date 914, the percentage completion and whether the item is ahead or behind schedule 916, the status of the item 918, whether any jeopardies/issues/risks (JIR) 920 have been recognized, the owner 940 of the JIR (i.e. responsible party) and target date 950 for solving the JIR, comments 930. An additional section 930 specifies significant risks, jeopardies, and issues that affect the software in the list for the selected program.

Referring now to FIG. 10, an illustrative embodiment of a general computer system associated with PARTS is shown and is designated 1000. The computer system 1000 can include a set of instructions that can be executed to cause the computer system 1000 to perform any one or more of the methods or computer based functions disclosed herein. The computer system 1000 may operate as a standalone device or may be connected, e.g., using a network, to other computer systems or peripheral devices.

In a networked deployment, the computer system 1000 may operate in the capacity of a server or as a client user computer in a server-client user network environment, or as a peer computer system in a peer-to-peer (or distributed) network environment. The computer system 1000 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 1000 can be implemented using electronic devices that provide voice, video or data communication. Further, while a single computer system 1000 is illustrated, the term “system” shall also be taken to include any collection of systems or sub-systems that individually or jointly execute a set, or multiple sets, of instructions to perform one or more computer functions.

As illustrated in FIG. 10, the computer system 1000 may include a processor 1002, e.g., a central processing unit (CPU), a graphics processing unit (GPU), or both. Moreover, the computer system 1000 can include a main memory 1004 and a static memory 1006 that can communicate with each other via a bus 1008. As shown, the computer system 1000 may further include a video display unit 1010, such as a liquid crystal display (LCD), an organic light emitting diode (OLED), a flat panel display, a solid state display, or a cathode ray tube (CRT). Additionally, the computer system 1000 may include an input device 1012, such as a keyboard, and a cursor control device 1014, such as a mouse. The computer system 1000 can also include a disk drive unit 1016, a signal generation device 1018, such as a speaker or remote control, and a network interface device 1020.

In a particular embodiment, as depicted in FIG. 10, the disk drive unit 1016 may include a computer-readable medium 1022 in which one or more sets of instructions 1024, e.g. software, can be embedded. Further, the instructions 1024 may embody one or more of the methods or logic as described herein. In a particular embodiment, the instructions 1024 may reside completely, or at least partially, within the main memory 1004, the static memory 1006, and/or within the processor 1002 during execution by the computer system 1000. The main memory 1004 and the processor 1002 also may include computer-readable media.

Alternatively, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 1024 or receives and executes instructions 1024 responsive to a propagated signal, so that a device connected to a network 1026 can communicate voice, video or data over the network 1026. Further, the instructions 1024 may be transmitted or received over the network 1026 via the network interface device 1020.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

As is apparent from the above figures, PARTS permits an extensive snapshot of all software and associated personnel to be taken at any point in time. Thus, any manager, director or other executive within the company may view pending applications, projects, or programs at any level of granularity desired, so long as the employee has access to the desired level of granularity. Thus, for example, cost and time estimates and ongoing budget/operating expenses, percentage completion, due date, and personnel for a particular application, project, or program may be reviewed at any point along the software development cycle. Using the information contained in PARTS, and tying it back to variables used to make the initial decisions regarding the software, permits further business decisions to be made on ongoing development of the software or the development of new software.

In one example, an assistant vice-president (AVP) may have 5-6 managers and 1000 people that report to him/her. Rather than getting different reports from each of the managers, however, the AVP can customize information that he or she wishes to concentrate on in a relatively short amount of time. The AVP can review all projects in his/her organization or examine the information by application or even work request, or can evaluate those impacting a particular director or project manager. In general, for a particular authorization, all information in the secured portion at lower granularity is accessible. Tables can be specifically tailored and printed for the manager. As indicated above, information such as work requests may be easily accessed without having to know the particular ID numbers beforehand.

Also, it is easy for a manager to see if the employee assigned to update PARTS with the information regarding an application/project/program is behind in updating the system. Thus, for example, a project manager may review the work requests, applications, and funding/personnel for all of the projects for which her/she is responsible, as well as being responsible for updating the temporary library storing the information before it is loaded into the databases. An upper level manager may, in turn, monitor the accomplishments of the project manager for the project simultaneously with reviewing other aspects of the project manager's performance in as much detail as desired and in light of the goals of the company.

In summary, PARTS provides a single tool for tracking information and measuring the information being tracked (including both software and resource information) while simultaneously being in compliance with CMM or other standard processes, thereby supplying desirable flexibility as the company grows. PARTS increases the ability of the information technology aspect of a company and the business aspect of the company to work closely with each other so that the software development work is in line with the strategic objectives of the overall company as well as individual business units within the company. PARTS has a high granularity of viewing for each detail as well as multiple ways of viewing various details. Granularity can be shown from an upper management layer of the company to a project manager layer to individual work orders. The granularity and flexibility permits the company to better allocate resources, both personnel and monetary, as well as better forecasting of operating expenses. The estimated operating expenses may be closer to the actual operating expenses, say within about 5%, to help make the company more profitable. This may also be applied to development for other, non-software, work.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

We claim:

1. A software development system comprising:
databases containing data related to software development and resources, the databases accessible to a limited number of employees within a company associated with the system;
a secured portion accessible to a greater number of employees within the company than the databases, access to various levels of granularity of information within the secured portion dependent on authorization of the particular employee attempting to access the information, the secured portion having a plurality of modules which contain at least some of the data from the databases; and
a display that permits the particular employee to view and enter desired authorized information contained within the secured portion dependent on the authorized level of granularity for the particular employee,
wherein the system is compliant with a standard model for developing software.

2. The system of claim 1, wherein:
the modules comprise a Force module that contains information about a work force of the company, a Project module that contains information about projects of the company, a Program module that contains information about programs of the company, a Resource Allocation module that involves planning of company resources, a Release Planning module that involves planning of release of software developed by the company, a Reporting module that provides reporting of various aspects of software development to a user, a Work Request module that contains information about the work requests that have been entered, and an Application module 136 that contains information about applications that have been developed or are under development,
the databases include a MOTS database that contains information of all of the software developed or in development by the company, a Phone database that contains information regarding the work force of the company, a VFD database that contains information for entry of all work requests, and a PIW database that contains information regarding programs, large projects, and applications of the company, and
the Phone database supplies data to the Force module, the MOTS database supplies data to the Application module, the VFD/Express database and PIW database supply data to the Work Request module and Program module, respectively, the Force module supplies data to the Application module, the Application module supplies data to the Resource Allocation module, the Resource Allocation module supplies data to the Project module as well as the Reporting module, the Project module supplies data to the Reporting module as well as the Release Planning module, the Program module supplies data to the Reporting module as well as the Release Planning module and the Project module, and the Work request module supplies data to the Project module.

3. The system of claim 1, wherein the data is automatically transferred from the databases to the secured portion but is not automatically transferred from the secured portion into the databases.

4. The system of claim 1, wherein, for a particular authorization, all information in the secured portion at lower granularity is accessible.

5. The system of claim 1, wherein the information within the secured portion accessible using a graphics user interface (GUI) is arranged graphically as folders containing links, the folders including: a Home folder, a Work Requests folder, a Projects folder, an Applications folder, a Force Management folder, and a Reporting folder.

6. The system of claim 5, wherein:
the Work Requests folder contains a list of titles and unique identification numbers of work requests in the secured portion,
the Projects folder contains a list of titles of projects in the secured portion, a unique identification number of work requests associated with each project, percentage completed of each project, and end date of each project on a single page,
the Projects folder contains a list of titles of projects in the secured portion, and for each project includes an identification number of an associated work request, a percentage completed, and an end date,
the Projects folder includes an analysis section that contains, for each project, accomplishments, phases, next steps, associated applications, issues, jeopardies, estimates, deliverables, and dependencies of the project,
the Applications folder includes a list of applications in the secured portion and a link for each application that indicates detailed information about the application, contact information of a manager and director for the application, and projects associated with the application,
the Force Management folder includes information of company personnel, the information searchable using a name, phone number, job title, and id number of an employee, the information containing contact information and associated applications of the employee,
wherein the Reporting folder contains a summary that includes, for each application or project: name, milestone currently being worked toward, estimated completion date, percentage completion, ahead or behind schedule, status, and recognized risks, jeopardies, and issues.

7. A method for tracking a software portfolio and resources of a company, the method comprising:
storing data related to software development and resources in databases;
permitting a limited number of employees within the company to access the databases;
permitting a greater number of employees within the company access to a secured portion than to the databases, the secured portion having a plurality of modules which contain at least some of the data from the databases;
granting different authorizations to different employees and permitting access to various levels of granularity of information within the secured portion dependent on the authorization of the particular employee attempting to access the information;
displaying desired authorized information contained within and permitting entry of information to the secured portion dependent on the authorized level of granularity for a particular employee; and
maintaining compliance of the software portfolio and resources with a standard model for developing software.

8. The method of claim 7, wherein:
the modules comprise a Force module that contains information about a work force of the company, a Project module that contains information about projects of the company, a Program module that contains information about programs of the company, a Resource Allocation module that involves planning of company resources, a Release Planning module that involves planning of release of software developed by the company, a Reporting module that provides reporting of various aspects of software development to a user, a Work Request module that contains information about the work requests that have been entered, and an Application module 136 that contains information about applications that have been developed or are under development, and
the databases include a MOTS database that contains information of all of the software developed or in development by the company, a Phone database that contains information regarding the work force of the company, a VFD database that contains information for entry of all work requests, and a PIW database that contains information regarding programs, large projects, and applications of the company.

9. The method of claim 8, further comprising:
supplying data to the Force module from the Phone database;
supplying data to the Application module from the MOTS database;
supplying data to the Work Request module from the VFD/Express database;
supplying data to the Program module from the PIW database;
supplying data to the Application module from the Force module;
supplying data to the Resource Allocation module from the Application module;
supplying data to the Project module and the Reporting module from the Resource Allocation module;
supplying data to the Reporting module and the Release Planning module from the Project module
supplying data to the Reporting module, the Release Planning module and the Project module from the Program module, and
supplying data to the Project module from the Work request module.

10. The method of claim 7, further comprising limiting transfer of the data such that data from the secured portion is not automatically transferred to the databases.

11. The method of claim 7, further comprising providing accessibility to all information in the secured portion at lower granularity for a particular authorization.

12. The method of claim 7, further comprising arranging the information within the secured portion accessible using a graphics user interface (GUI) graphically as folders containing links, the folders including: a Home folder, a Work Requests folder, a Projects folder, an Applications folder, a Force Management folder, and a Reporting folder.

13. The method of claim 12, wherein:
the Work Requests folder contains a list of titles and unique identification numbers of work requests in the secured portion,
the Projects folder contains a list of titles of projects in the secured portion, a unique identification number of work requests associated with each project, percentage completed of each project, and end date of each project on a single page,
the Projects folder contains a list of titles of projects in the secured portion, and for each project includes an identification number of an associated work request, a percentage completed, and an end date,
the Projects folder includes an analysis section that contains, for each project, accomplishments, phases, next steps, associated applications, issues, jeopardies, estimates, deliverables, and dependencies of the project,
the Applications folder includes a list of applications in the secured portion and a link for each application that indicates detailed information about the application, contact information of a manager and director for the application, and projects associated with the application,
the Force Management folder includes information of company personnel, the information searchable using a name, phone number, job title, and id number of an employee, the information containing contact information and associated applications of the employee, and
the Reporting folder contains a summary that includes, for each application or project: name, milestone currently being worked toward, estimated completion date, percentage completion, ahead or behind schedule, status, and recognized risks, jeopardies, and issues.

14. A computer readable medium containing instructions for tracking a software portfolio and resources of a company, the computer readable medium comprising:
a routine for storing data related to software development and resources in databases;
a routine for permitting a limited number of employees within the company to access the databases;
a routine for permitting a greater number of employees within the company access to a secured portion than to the databases, the secured portion having a plurality of modules which contain at least some of the data from the databases;
a routine for granting different authorizations to different employees and permitting access to various levels of granularity of information within the secured portion dependent on the authorization of the particular employee attempting to access the information;
a routine for displaying desired authorized information and permitting entry of information contained within the secured portion dependent on the authorized level of granularity for a particular employee; and
a routine for maintaining compliance of the software portfolio and resources with a standard model for developing software.

15. The computer readable medium of claim 14, wherein:
the modules comprise a Force module that contains information about a work force of the company, a Project module that contains information about projects of the company, a Program module that contains information about programs of the company, a Resource Allocation module that involves planning of company resources, a Release Planning module that involves planning of release of software developed by the company, a Reporting module that provides reporting of various aspects of software development to a user, a Work Request module that contains information about the work requests that have been entered, and an Application module 136 that contains information about applications that have been developed or are under development, and
the databases include a MOTS database that contains information of all of the software developed or in development by the company, a Phone database that contains information regarding the work force of the company, a VFD database that contains information for entry of all work requests, and a PIW database that contains information regarding programs, large projects, and applications of the company.

16. The computer readable medium of claim 14, further comprising:
a routine for supplying data to the Force module from the Phone database;
a routine for supplying data to the Application module from the MOTS database;
a routine for supplying data to the Work Request module from the VFD/Express database;
a routine for supplying data to the Program module from the PIW database;
a routine for supplying data to the Application module from the Force module;
a routine for supplying data to the Resource Allocation module from the Application module;
a routine for supplying data to the Project module and the Reporting module from the Resource Allocation module;
a routine for supplying data to the Reporting module and the Release Planning module from the Project module
a routine for supplying data to the Reporting module, the Release Planning module and the Project module from the Program module, and
a routine for supplying data to the Project module from the Work request module.

17. The computer readable medium of claim 14, further comprising a routine for limiting transfer of the data such that data from the secured portion is not automatically transferred to the databases.

18. The computer readable medium of claim 14, further comprising a routine for providing accessibility to all information in the secured portion at lower granularity for a particular authorization.

19. The computer readable medium of claim 14, further comprising a routine for arranging the information within the secured portion accessible using a graphics user interface (GUI) graphically as folders containing links, the folders including: a Home folder, a Work Requests folder, a Projects folder, an Applications folder, a Force Management folder, and a Reporting folder.

20. The computer readable medium of claim 19, wherein:
the Work Requests folder contains a list of titles and unique identification numbers of work requests in the secured portion,
the Projects folder contains a list of titles of projects in the secured portion, a unique identification number of work requests associated with each project, percentage completed of each project, and end date of each project on a single page,
the Projects folder contains a list of titles of projects in the secured portion, and for each project includes an identification number of an associated work request, a percentage completed, and an end date,
the Projects folder includes an analysis section that contains, for each project, accomplishments, phases, next steps, associated applications, issues, jeopardies, estimates, deliverables, and dependencies of the project,
the Applications folder includes a list of applications in the secured portion and a link for each application that indicates detailed information about the application, contact information of a manager and director for the application, and projects associated with the application,
the Force Management folder includes information of company personnel, the information searchable using a name, phone number, job title, and id number of an employee, the information containing contact information and associated applications of the employee, and
the Reporting folder contains a summary that includes, for each application or project: name, milestone currently being worked toward, estimated completion date, percentage completion, ahead or behind schedule, status, and recognized risks, jeopardies, and issues.

21. The computer readable medium of claim 14, further comprising a routine for taking snapshots of the information in the secured portion over a development cycle of software being developed with a desired granularity
